(19) United States
(12) Patent Application Publication
(10) Pub. No.: US 2007/0134421 A1
(43) Pub. Date: Jun. 14, 2007

(54) Surface relief ornament coating method, template and coating device used therein, and ornamental plate made therefrom

(76) Inventor: Chi Kong Cheung, Santo Domingo (DO)

Correspondence Address: SHELDON MAK ROSE & ANDERSON PC, 225 SOUTH LAKE AVENUE, 9TH FLOOR, PASADENA, CA, 91101, US

(21) Appl. No.: 11/520,094

(22) Filed: Sep. 12, 2006

(30) Foreign Application Priority Data
Dec. 14, 2005 (CN) 200520120431.8
Dec. 14, 2005 (CN) 200520120433.7
Jan. 18, 2006 (CN) 200610033050.5
Mar. 29, 2006 (CN) 200620057094.7

(51) Int. Cl. B05D 1/32; B05D 1/36; B05C 1/00

(52) U.S. Cl. 427/282; 427/402; 118/213

(57) ABSTRACT

Disclosed is a new surface coating method, by which a clear-cut relief ornament can be formed on a surface, comprising: i) providing a template having a patterned surface, wherein the pattern on the surface is a three-dimensional pattern; ii) covering the patterned surface of the template with a coating slurry; iii) placing the template onto a working surface to be coated with the patterned surface facing the working surface; and iv) removing the template. Also disclosed are a template and a coating device used in the method and an ornamental plate manufacture with the method.

### CROSS REFERENCE OF RELATED APPLICATIONS

The present application claims the benefits of Chinese application No. 200520120431.8 filed on Dec. 14, 2005, Chinese application No. 200520120433.7 filed on Dec. 14, 2005, Chinese application No. 200610033050.5 filed on Jan. 18, 2006, and Chinese application No. 200620057094.7 filed on Mar. 29, 2006, which are explicitly incorporated herein by reference in their entireties.

### BACKGROUND OF THE INVENTION

1. Technical Field of the Invention

The present invention relates to a surface coating method, particularly to a surface relief ornament coating method, a template and a coating device used in the method and an ornamental plate manufactured with the method.

2. Description of Prior Art

Up to now, various methods have been developed for architectural decoration, especially for coating of the surface of buildings. Among these methods, those, by which a relief pattern can be formed on the surface of a wall, are most popular.

Chinese application Nos. 02146563.0 and 88108127.2 disclose a surface decorating method comprising providing a three-dimensional article and attaching the article to a surface with a binder. This method is disadvantageous in that the binding of the article to the surface is not strong enough, and the binder may deteriorate the appearance of the decorated surface. In addition, the storage and conveyance of the premade three-dimensional article are troublesome.

Chinese application Nos. 02146469.3, 03152967.4 and 90108120.5 disclose a surface coating method comprising providing a template with patterned notches, covering a surface with the template, spraying or scraping a coating slurry to fill the notches in the template and removing the template. However, only simple patterns can be formed on surfaces by using this method, and the patterns formed may be damaged when removing the template.

In Chinese application No. 200410077465.3, there is disclosed a surface relief ornament coating method comprising scraping a coating slurry onto the wall surface, placing a template with a relief pattern onto the coated surface, pressing the template, and removing the template. The method is disadvantageous in that the ornament formed on the surface by using this method is not clear-cut and may have defects like bubbles.

### SUMMARY OF THE INVENTION

To overcome the defects in the prior art, the present invention provides a new surface coating method, by which a clear-cut relief ornament can be formed on a surface, a template and a coating device used therein and an ornamental plate made therefrom.

According to an aspect of the present invention, there is provided a surface relief ornament coating method comprising:

i) providing a template having a patterned surface, in which the pattern on the surface is a three-dimensional pattern;

ii) covering the patterned surface of the template with a coating slurry;

iii) placing the template onto a working surface to be coated with the patterned surface facing the working surface; and

iv) removing the template.

According to another aspect of the present invention, there is provided a template having a patterned surface, in which the pattern on the surface is a three-dimensional pattern.

According to still another aspect of the present invention, there is provided a coating device comprising a U shaped frame having two arms, a handspike connected to the frame, and a roller arranged between the two arms of the frame, in which each arm of the frame extends outward from the plane of the U shaped frame to form an extended arm, and a rolling shaft is provided between the two extended arms parallel to the roller.

According to a further aspect of the present invention, there is provided an ornamental plate comprising a plate body and an ornamental layer provided thereon, in which a three-dimensional pattern is formed on the ornamental layer.

### BRIEF DESCRIPTION OF THE DRAWINGS

FIG. 1 is a schematic diagram showing an exemplary template of the invention.

FIG. 2 is a schematic diagram showing an exemplary coating device of the invention.

FIG. 3 is a schematic diagram showing the working state of the coating device shown in FIG. 2.

FIG. 4 shows the left view of an exemplary ornamental plate of the invention.

FIG. 5 shows the front view of the ornamental plate shown in FIG. 4.

### DETAILED DESCRIPTION OF THE INVENTION

In a first aspect of the present invention, there is provided a surface relief ornament coating method comprising the steps of:

i) providing a template having a patterned surface, in which the pattern on the surface is a three-dimensional pattern;

ii) covering the patterned surface of the template with a coating slurry;

iii) placing the template onto a working surface to be coated with the patterned surface facing the working surface; and

iv) removing the template.

Preferably, the coating slurry contains 40%-80% by weight of gesso and 5%-40% by weight of water or gluewater.

More preferably, the coating slurry may further contain 5%-10% by weight of coloring powder and/or 10%-30% by weight of lithopone.

In a preferred embodiment of the invention, the template is removed in 20-60 minutes after step iii) leaving a relief ornament on the working surface.

In another preferred embodiment of the present invention, after step iv), the working surface is further painted with a color paint or a reflective paint so that the relief ornament on the surface may look more colorful, clear-cut or reflective, or show various appearances when observed from different angles.

If the working surface to be coated is an unfinished wall surface, the method of the present invention may further comprise the step of applying a prime paint onto the wall surface before step iii).

Preferably, the prime paint contains 30%-50% by weight of epoxy-resin and 50%-70% by weight of calcium carbonate.

The method of the present invention can be applied to a surface of any solid material, such as metal, wood, cement, stone, plastic, glass and the like. Also, the method of the invention can be applied to any smooth surface including flat and curved surfaces.

In a second aspect of the present invention, there is provided a template having a patterned surface, in which the pattern on the surface is a three-dimensional pattern.

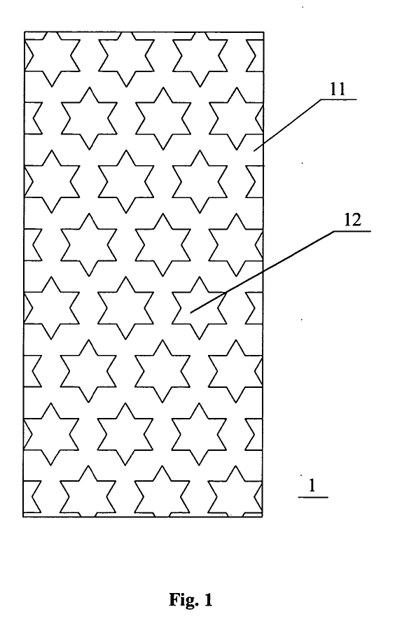

An exemplary template of the invention is as shown in FIG. 1, in which a template 1 has a patterned surface 11 with a three-dimensional pattern 12 provided thereon.

Preferably, the template is transparent so that a coating process carried out using the template can be monitored visually through the template. Hence, bubbles or other defects formed during the coating process can be observed and eliminated before the formation of the relief ornament.

For the convenience of storage, conveyance and use, the template is preferably made of flexible materials including, but not limited to, plastic and rubber. And preferably, the three-dimensional pattern on the template is an incused pattern.

In a preferred embodiment of the invention, the thickness of the three-dimensional pattern on the template is less than 2.00 mm.

In a third aspect of the present invention, there is provided a coating device comprising a U shaped frame having two arms, a handspike connected to the frame and a roller provided between the two arms of the frame, in which each arm of the frame extends outward from the plane of the U shaped frame to form an extended arm, and a rolling shaft is provided between the two extended arms parallel to the roller.

A coating process carried out using the coating device of the invention may be illustrated as follows. A coating material such as a template of the invention or a wallpaper is firstly coiled around the rolling shaft of the coating device with an end free. The free end of the coating material is attached to a working surface to be coated and the roller of the coating device is then placed thereon so that the coating material between the roller and the rolling shaft defines a “V” shaped space together with the working surface. An appropriate amount of slurry is added to the “V” shaped space, and thus the working surface and the coating material defining the space are coated by the slurry. The coating device is then pushed along the working surface so that the coating material is continuously released from the rolling shaft, coated by the slurry, pressed by the roller and attached to the working surface. Therefore, the processes of coating a working surface with a slurry, covering the coated surface with a coating material and pressing the coating material against the coated surface are accomplished simultaneously. Furthermore, the ratio of the slurry to the coating material can be controlled to make the coating process more cost-effective.

To prevent the slurry added between the coating material and the working surface from leaking out from the two sides of the coating device, an elastic baffle plate is provided at the inner side of each extended arm of the coating device, which extends from the roller towards the rolling shaft. The size of the baffle plate is selected to enable the baffle plate to touch the working surface to prevent the slurry from leaking out.

Preferably, the roller is connected rotatablely to the U shaped frame via a shaft and the baffle plate is mounted on the shaft of the roller such that it can be easily removed and replaced. Alternatively, the baffle plate may be mounted on the rolling shaft or both the shaft of the roller and the rolling shaft.

Normally, during the coating process, the force applied to the coating device via the handspike may vary, such as in direction, which may cause the baffle plate to be detached from the working surface. As a result, the coating slurry may leak out through the gap between the baffle plate and the working surface. Therefore, preferably the baffle plate is installed movably on the rolling shaft and/or the shaft of the roller, and an elastic protecting slice is provided for each baffle plate. One end of the protecting slice is fixed on the U shaped frame and the other end is placed on the baffle plate, so that the baffle plate is pressed by the protecting slice to keep in close touch with the working surface in despite of the variety of the force applied to the coating device.

Preferably, the handspike of the coating device is extendable so that the coating device of the invention is adapted to working surfaces at various heights.

To make the force delivered from the handspike to the U shaped frame more uniformly so as to achieve better coating effects, an elastomeric unit is preferably provided between the extendable handspike and the U shaped frame. One end of the elastomeric unit is connected to the handspike and the other end is connected to the middle part of the U shaped frame.

Preferably, the elastomeric unit comprises a rigid sleeve and a spring provided inside the sleeve along the axis thereof. One end of the handspike is inserted into the sleeve and connected to the spring, and the other end of the handspike remains outside the sleeve.

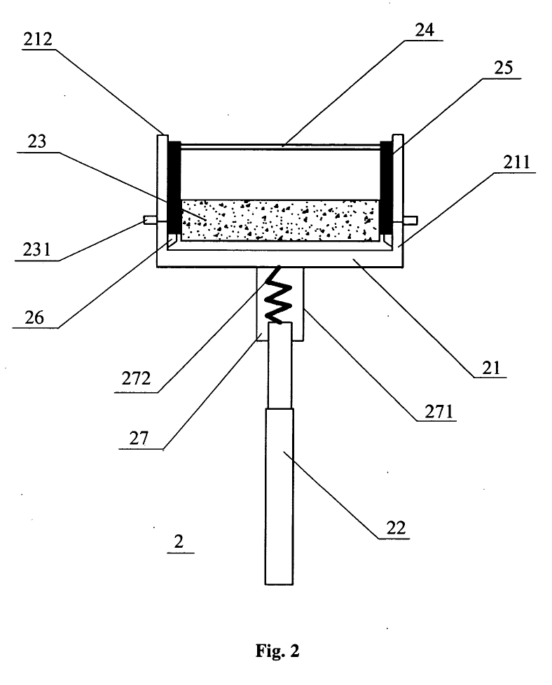

As shown in FIG. 2, an exemplary coating device 2 comprises a U shaped frame 21 having two arms 211, a handspike 22 connected to the frame 21 and a roller 23 arranged rotatablely between the two arms 211. The roller 23 is connected to the frame 21 via a shaft 231. Each arm 211 extends out forming an extended arm 212. A rolling shaft 24 is provided between the two extended arms 212 parallel to the roller 23. An elastic baffle plate 25 is mounted on the shaft 231 at the inner side of each extended arm 212. An elastic protecting slice 26 is provided at the back side of each baffle plate 25. The handspike 22 is connected to the U shaped frame 21 via an elastomeric unit 27 which comprises a rigid sleeve 271 and a spring 272.

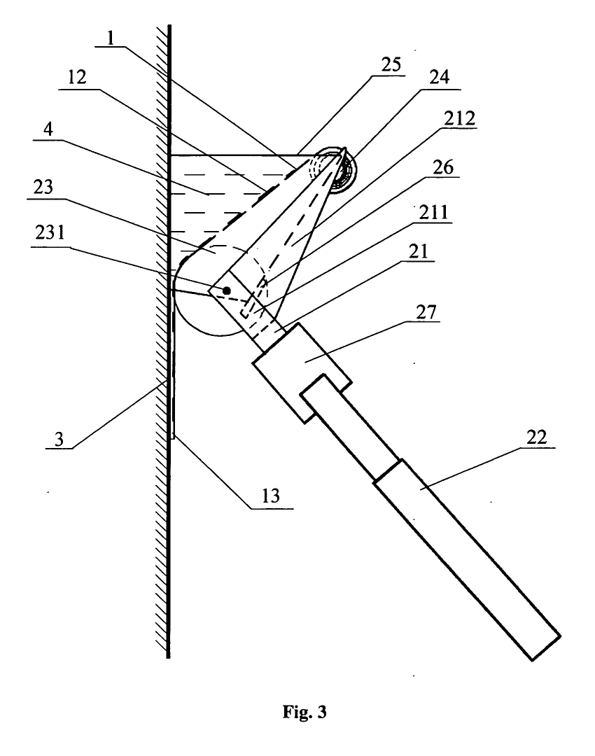

As shown in FIG. 3, when used in a coating process, the template 1 is firstly coiled around the rolling shaft 24 of the coating device 2 with the three-dimensional pattern 12 facing outwards and an end 13 released. The released end 13 is attached to a vertical working surface 3 and the roller 23 is then pressed on the end 13 so that the coating material 1 between the roller 23 and the rolling shaft 24, the working surface 3 and the baffle plates 25 define a “V” shaped space. An appropriate amount of slurry 4 is added to the “V” shaped space; thereby the template 1 is coated by the slurry 4 on the three-dimensional pattern 12. The coating device 2 is then pushed upwards along the working surface 3 so that the template 1 is continuously released from the rolling shaft 24, coated by the slurry 4, pressed by the roller 23 and attached to the working surface 3. As a result, the slurry 4 coated on the three-dimensional pattern 12 is hold between the template 1 and the working surface 3.

In a fourth aspect of the present invention, there is provided an ornamental plate comprising a plate body and an ornamental layer provided thereon, in which a three-dimensional pattern is provided on the ornamental layer.

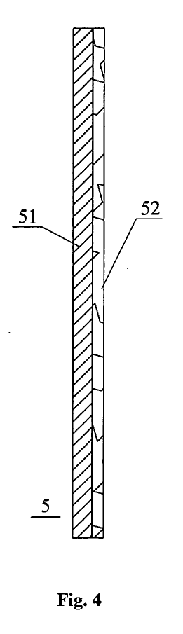

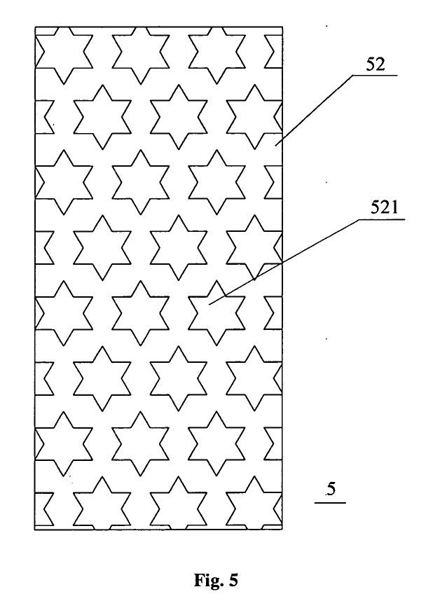

An exemplary ornamental plate of the invention is as shown in FIG. 4 and FIG. 5, in which an ornamental plate 5 comprises a plate body 51 and an ornamental layer 52, and a three-dimensional pattern 521 is provided on the ornamental layer 52.

Preferably, the ornamental layer is made of a material selected from the group consisting of a waterproof material, an epoxy-resin material and a gypsum and PVA composite material.

Preferably, the plate body is made of conventional solid materials including, by not limited to, metal, wood, cement, stone, paper, glass, plastic and the like. More preferably, the plate body is selected from the group consisting of a plywood plate, an asbestos cement plate, a paper-surface plaster plate and a corrugated board.

Hereinafter, the invention will be illustrated more in detail by the following examples with reference to the drawings for better understanding of various aspects and advantages of the invention. However, it should be understood that the examples below are non-limiting and are only illustrative of some of the embodiments of the present invention.

### EXAMPLES

### Example 1

A template 1 having a thickness of 0.5-2.0 mm with an incused pattern 12 was placed horizontally with the patterned surface 11 facing upwards. A coating slurry containing 70 wt. % gesso and 30 wt. % water was then poured onto the template 1. After the slurry on the template 1 was partially hardened, the template 1 was placed onto a wall surface with the patterned surface 11 facing the wall surface. The template 1 was then pressed uniformly from back to make it tightly attached to the wall surface. After 30 minutes, the template 1 was removed leaving a relief pattern on the wall surface. The process was repeated till the whole surface of wall was coated.

### Example 2

A prime paint containing 30 wt. % epoxy-resin and 70 wt. % calcium carbonate was firstly painted on an unfinished wall surface. Then the surface was coated in the same manner as described in Example 1 except that a coating slurry containing 60 wt. % gesso, 32 wt. % gluewater and 8 wt. % coloring powder was used.

### Example 3

A wall surface was coated in the same manner as described in Example 2 except that a prime paint containing 40 wt. % epoxy-resin and 60 wt. % calcium carbonate, and a coating slurry containing 70 wt. % gesso, 20 wt. % gluewater and 10 wt. % coloring powder were used.

1. A surface relief ornament coating method, the method comprising:
i) providing a template having a patterned surface, wherein the pattern on the surface is a three-dimensional pattern;
ii) covering the patterned surface of the template with a coating slurry;
iii) placing the template onto a working surface to be coated with the patterned surface facing the working surface; and
iv) removing the template.

2. The method according to claim 1, further comprising painting the working surface with a color paint or a reflective paint after step iv).

3. The method according to claim 1, wherein the coating slurry comprises 40%-80% by weight of gesso and 5%-40% by weight of water or gluewater.

4. The method according to claim 3, wherein the coating slurry further comprises 5%-10% by weight of coloring powder or comprises 10%-30% by weight of lithopone, or comprises both 5%-10% by weight of coloring powder and comprises 10%-30% by weight of lithopone.

5. The method according to claim 1, further comprising applying a prime paint onto the working surface before step iii).

6. The method according to claim 5, wherein the prime paint comprises 30%-50% by weight of epoxy-resin and 50%-70% by weight of calcium carbonate.

7. A template having a patterned surface, wherein the pattern on the surface is a three-dimensional pattern.

8. The template according to claim 7, wherein the template is transparent.

9. The template according to claim 7, wherein the template is made of a flexible material.

10. The template according to claim 7, wherein the three-dimensional pattern is an incused pattern.

11. A coating device comprising:
a U shaped frame having two arms;
a handspike connected to the U shaped frame;
a roller arranged between the two arms of the frame, wherein each of the arms extends outward from the plane of the frame to form an extended arm; and
a rolling shaft provided between the two extended arms parallel to the roller.

12. The coating device according to claim 11, further comprising an elastic baffle plate provided at the inner side of each of the extended arms.

13. The coating device according to claim 12, wherein the roller is connected to the frame via a shaft, and wherein each of the baffle plates is installed on the shaft of the roller, or is installed on the rolling shaft, or is installed on both the shaft of the roller and the rolling shaft.

14. The coating device according to claim 12, further comprising an elastic protecting slice provided for each of the baffle plates, wherein one end of the protecting slice is fixed to the frame and the other end of the protecting slice is placed on the corresponding baffle plate.

15. The coating device according to claim 11, wherein the handspike is extendable.

16. The coating device according to claim 15, wherein the handspike is connected to the frame via an elastomeric unit.

17. The coating device according to claim 16, wherein the elastomeric unit comprises a rigid sleeve and a spring provided inside the sleeve along the axis thereof, wherein one end of the handspike is inserted into the sleeve and connected to the spring.

18. An ornamental plate comprising a plate body and an ornamental layer provided thereon, wherein a three-dimensional pattern is provided on the ornamental layer.

19. The ornamental plate according to claim 18, wherein the ornamental layer comprises a material selected from the group consisting of a waterproof material, an epoxy-resin material and a gypsum and PVA composite material.

20. The ornamental plate according to claim 18, wherein the plate body is selected from the group consisting of a plywood plate, an asbestos cement plate, a paper-surface plaster plate and a corrugated board.
